(19) United States
(12) Patent Application Publication
(10) Pub. No.: US 2024/0384868 A1
(43) Pub. Date: Nov. 21, 2024

(54) BURNER FOR IMPLEMENTING PARTIAL OXIDATION

(71) Applicant: LINDE GMBH, Pullach (DE)

(72) Inventors: Dieter MIHAILOWITSCH, Pullach (DE); Martin MURER, Pullach (DE)

(21) Appl. No.: 18/575,662

(22) PCT Filed: Jun. 1, 2022
(86) PCT No.: PCT/EP2022/025257

§ 371 Date: Dec. 29, 2023

(30) Foreign Application Priority Data
Jul. 5, 2021 (EP) 21020351.9

(51) Int. Cl. F23D 14/22; C01B 3/36; C01B 32/40; F23D 14/66; F23D 14/78

(52) U.S. Cl. CPC F23D 14/22; C01B 3/363; C01B 32/40; F23D 14/66; F23D 14/78; C01B 2203/0255; C01B 2203/1241; F23D 2212/10; F23D 2900/00018

(57) ABSTRACT

A burner for implementing a partial oxidation, having at least two channels, more particularly having one central channel and at least one annular channel surrounding the central channel, through each of which a flow of fluid can be passed to implement the partial oxidation, there being an insulating element arranged on an inner face of a wall of at least one channel of the at least two channels at least along part of an axial length of this at least one channel.

The invention relates to a burner for implementing a partial oxidation with at least two channels through each of which a fluid can flow for implementing the partial oxidation.

### BACKGROUND OF THE INVENTION

In the course of partial oxidation, a hydrocarbon-containing fuel, e.g. natural gas, petroleum gas or fuel gas, can be partially combusted with an oxidizing agent, for example in the form of an oxygen-containing gas, e.g. oxygen or air or a mixture thereof, in a substoichiometric mixing ratio to produce a synthesis gas. A mixture of carbon monoxide and hydrogen is produced as the synthesis gas, which can be used in fuel cells, for example. Further, a moderator can be added to the fuel and/or oxidizer, for example water vapor or carbon dioxide, to regulate a ratio between hydrogen and carbon monoxide in the synthesis gas produced or for safety reasons to automatically perform a purge of the burner in the event of a fault or malfunction.

Burners for partial oxidation can be designed as multi-channel burners with a plurality of concentric channels, through each of which a fluid can flow. In most cases, such a burner has a central channel and one or more annular channels surrounding this central channel. Further, a cooling channel for a cooling fluid, e.g. water, can be provided in one or more walls of the burner to cool the burner.

A burner tip can be provided at a front end of the burner as viewed in the direction of flow of the fluids, which can be designed in the shape of a truncated cone, for example. In this burner tip, for example, the outer annular channels can extend towards the central channel at a predetermined angle of inclination or outlet angle. In this manner, the fluids guided through the annular channels can each be emitted or discharged from the burner tip at a predetermined angle of inclination or outlet angle relative to a fluid flow from the central core.

For example, U.S. Pat. No. 4,888,031 A describes a method for partial oxidation by means of a concentric burner arrangement consisting of four concentric ring channels and a central channel.

For example, U.S. Pat. No. 3,255,966 A discloses a burner for partial oxidation with an inner channel and an annular outer channel concentric with the inner channel. Cooling channels for a cooling fluid to cool the burner are provided in an outer wall of the burner.

U.S. Pat. No. 4,865,542 A shows for example a burner for partial oxidation with an inner channel and two concentric, ring-shaped channels. A supply line and a drain for a cooling fluid are provided in one wall of the burner. The inlet and outlet are connected to one another via a spiral channel in the tip of the burner.

### DISCLOSURE OF THE INVENTION

Against this background, a burner for partial oxidation with the features of claim 1 is proposed. Advantageous embodiments are the subject-matter of the dependent claims and of the following description.

The burner is intended for partial oxidation of fluids, in particular a hydrocarbon-containing fuel, e.g. natural gas, petroleum gas or fuel gas, and an oxidizing agent, particularly in the form of an oxygen-containing gas, e.g. oxygen or air or a mixture thereof. The burner has at least two channels through each of which a fluid can flow for implementing partial oxidation. In particular, the burner has a central channel and at least one annular channel surrounding this central channel. Conveniently, the individual channels can each be connected to a corresponding fluid supply.

An insulation element is arranged on an inner face or on an inner side of a wall of at least one channel of the at least two channels along at least part of an axial length of this at least one channel. The respective channel is conveniently limited by this wall radially outwards or outwards in a radial direction. This wall is thus to be understood in particular as a radial wall or boundary wall of the respective channel. The inner face or inner side is to be understood in particular as an inner surface of this wall in the radial direction. This inner face or inner wall face or inner wall side is thus expediently to be understood as the (upper) surface of the wall facing the fluid flow of the respective channel, in contrast to the outer (upper) face or outer wall surface or outer wall side of the wall facing away from the fluid flow of the respective channel. The insulation element, which is arranged on this inner face, is thus particularly in direct contact with the fluid flowing through the respective channel. Ideally, the insulation element surrounds the corresponding channel in a ring shape.

This insulation element is provided in the respective channel particularly in order to thermally insulate a fluid flowing through the channel, expediently with respect to parts of the burner located further out in the radial direction. In particular, this fluid can be insulated or shielded or protected from thermal influences, for example from heat sources or heat sinks, in these burner parts located further out. Conversely, these burner parts located further out, and further particularly a fluid flowing through these parts, can be insulated or shielded or protected from thermal influences of the fluid within the channel provided with the insulation element. In particular, it is thus possible to ensure that the fluid flowing in the corresponding channel provided with the insulation element is heated or cooled less by external temperature influences. Conversely, it is expedient to ensure that a fluid flowing in the burner parts located further out is heated or cooled less by the fluid flowing in the insulated channel.

In particular, the insulation element can reduce thermal effects such as heat exchange within the burner. For example, a desired or predetermined temperature difference between the outer burner parts and the fluid in the insulated channel can be maintained or at least a reduction in this temperature difference due to heat exchange can be reduced. Thermal stresses within the burner, particularly thermal stresses or mechanical stresses due to thermal stresses, can be expediently avoided or at least reduced.

The present invention provides a particularly effective means of thermally insulating components or fluids within the burner. This particularly increases the effectiveness of the burner. Loads within the burner can be reduced. Defects and repairs can be avoided. Maintenance intervals can be extended. Costs can be reduced. The service life of the burner and its individual components can be increased. The arrangement of the insulation element on the inner wall face, i.e. inside the respective channel, enables particularly space-saving, flexible and effective insulation. For example, a burner can be retrofitted with appropriate insulation elements in a structurally simple and low-cost manner.

According to a particularly preferred embodiment, the burner also has at least one cooling channel through which a cooling fluid can flow to cool the burner. Advantageously, the at least one cooling channel, particularly when viewed in a radial direction, surrounds the at least two channels in a ring shape. In particular, this at least one cooling channel is provided in a wall of the burner and, particularly when viewed in the radial direction, is arranged outside the at least two channels or radially adjacent to the at least two channels. Expediently, the at least one cooling channel can be connected to a cooling fluid inlet and a cooling fluid outlet in order to expediently allow cooling fluid to flow continuously from the cooling fluid inlet through the at least one cooling channel to the cooling fluid outlet for cooling the burner. For example, water can be used as a cooling fluid.

Particularly advantageously, the insulation element is arranged on the inner wall of the channel of the at least two channels adjacent to the at least one cooling channel, at least along part of an axial length of this adjacent channel. The insulated channel is particularly conveniently arranged directly adjacent to the at least one cooling channel when viewed in a radial direction. It is particularly practical for the at least one cooling channel to directly surround this insulated channel in the form of a ring. For example, the channel provided with the insulation element can be an outer channel of the at least two channels when viewed in the radial direction. For example, the cooling channel can be arranged in the wall of the corresponding insulated channel. Further, the wall of the insulated channel can, for example, correspond to the outer wall of the burner.

The insulation element is particularly useful for preventing or at least reducing heat transfer from the fluid in the insulated channel to the cooling fluid. In this manner, it is expedient to prevent or at least reduce the cooling fluid from heating up due to the temperature of the fluid flowing through the insulated channel. The cooling of the burner can thus be performed more effectively. Further, the amount of cooling fluid required for cooling can be reduced in particular.

Due to a temperature difference between the temperature of the cooling fluid in the cooling channel and the temperature of the fluid in the immediately adjacent channel, large thermal or mechanical stresses could occur in the wall of this adjacent channel. By arranging the insulation element on the inner wall face of this adjacent channel, such stresses in the wall can be significantly reduced. The service life of the burner can thus be increased.

The individual fluids in the burner channels can contain water vapor, for example. Water vapor can be conveniently added to the fuel, for example to regulate a ratio between hydrogen and carbon monoxide in the synthesis gas produced, or for safety reasons, for example to automatically perform a purge of the burner in the event of a fault or malfunction. A high partial pressure could cause the water vapor to condense on a cold wall to an adjacent cooling channel, creating droplets that could damage the burner tip through erosion. Such condensation of water vapor can be prevented by the arrangement of the insulation element on the inner wall face of the channel adjacent to the cooling channel. This prevents damage to the burner and increases the service life of the burner.

In accordance with a preferred embodiment, the at least one channel is configured to be connected to a fluid supply for supplying a preheated fluid and/or a fuel, particularly a preheated fuel. For example, the fluid, particularly the fuel, can be preheated to temperatures of up to 800° C. The insulation element can usefully prevent or at least reduce the cooling of this preheated fluid due to a temperature difference to a neighboring burner part located further out. The efficiency of preheating can thus be increased and, in particular, the amount of energy required for preheating can be reduced. Further, thermal expansion of the channel wall due to the high temperatures of the fluid can be compensated for or prevented or at least reduced.

If, particularly advantageously, the at least one cooling channel is provided adjacent to the channel insulated with the insulation element, heating of the cooling fluid due to the higher temperature of the preheated fluid can be prevented or at least reduced. Conversely, cooling of the preheated fluid can be reduced or at least minimized due to the low temperature of the cooling fluid. For example, the temperature of the cooling fluid can be limited to approx. 60° C., whereas the preheated fluid is heated to temperatures of up to approx. 800° C., for example. The insulation element can expediently prevent or reduce stresses in the wall of the corresponding channel due to this high temperature difference of several hundred degrees.

Preferably, the insulation element can be removed or replaced from the at least one channel. The insulation element can be removed and reinserted or replaced with a new insulation element in a particularly simple and low-cost manner in the event of damage or for maintenance, cleaning or repair work. In particular, the insulation element is therefore not firmly connected to the wall of the at least one channel. Conveniently, the insulation element can be inserted into the corresponding channel. In particular, the insulation element can be axially displaceable within the corresponding channel. This allows the axial position of the insulation element relative to the channel or relative to the burner to be changed and adjusted as required.

Preferably, the insulation element is arranged in the at least one channel at least from a rear end, viewed in the direction of flow, of the at least one channel to a position which is at a predeterminable or predetermined axial distance from a front end, viewed in the direction of flow, of the at least one channel. The front end corresponds in particular to one end of the burner tip, at which the individual fluids are emitted or discharged from the burner. In particular, this axial position, up to which the insulation element extends, can be determined by the design or, for example, be specified depending on thermal, thermodynamic or fluid dynamic conditions within the corresponding channel.

Alternatively or additionally, the insulation element is preferably arranged in the at least one channel at least from a fluid port for supplying a fluid into the at least one channel to a position which is at a predeterminable or predetermined axial distance from a front end of the at least one channel as viewed in the flow direction. In particular, the fluid within the corresponding channel can thus be isolated from the fluid port, i.e. expediently from the axial position at which the fluid is directed into the channel.

Preferably, the insulation element extends in the axial direction in the at least one channel up to a burner tip, particularly up to the beginning of the burner tip viewed in the direction of flow. Conveniently, the position explained above in the predeterminable axial distance from the front end of the channel, up to which the insulation element is arranged, corresponds to the beginning of the burner tip. The burner tip can, for example, be designed in the shape of a truncated cone. In the burner tip, the annular channels can extend towards the central channel at a predetermined angle of inclination or outlet angle. In particular, the insulation element can be arranged in an axial area of the respective channel in which this channel or its wall extends parallel or at least substantially parallel to a longitudinal axis of the burner or to a longitudinal axis of the central channel. The insulation element expediently extends within the respective channel up to the position from which the channel or its wall bends and extends towards the central channel at the corresponding angle of inclination or outlet angle.

Preferably, the insulation element is designed as a tube or as a tubular element. In particular, this enables the insulation element to be easily inserted into and removed from the respective channel, which is also expediently formed by a tube or tubular element. A shape of the insulation element and a shape of the respective channel or a shape of the channel along the respective part in which the insulation element is arranged correspond to each other particularly appropriately or correspond to one another at least substantially. Particularly expediently, a shape of an outer surface of a wall of the insulation element corresponds, at least substantially, to a shape of the inner face of the wall of the channel. The insulation element can therefore be inserted into the channel with a tight fit or form closure, so that no fixed connection is required and the insulation element can be easily removed again.

Advantageously, the insulation element is made of a thermally insulating material. In particular, the thermally insulating material can withstand high temperatures which the fluid may have inside the corresponding channel, and further particularly high temperature differences between the temperature of the fluid inside the channel and a temperature outside the channel, expediently a temperature of a cooling fluid outside the channel.

In accordance with a particularly advantageous embodiment, the insulation element is made of a mica material or mica material. Mica is a mineral that consists mainly of silicon (Si), aluminum (Al), magnesium (Mg) and potassium (K). The structure is formed by many layers of sheet-like frame layers consisting of Si, Al (or Mg) oxides and K ion layers. As mica is a natural, inorganic mineral, it has very good heat resistance properties and is particularly suitable as a material for the insulation element. For example, the insulation element can be made of muscovite or phlogopite or of a material containing muscovite and/or phlogopite. Muscovite, KAl₂(Si₃Al)O₁₀(OH)₂, for example, can withstand temperatures of up to 800° C., phlogopite, KMg₃(Si₃Al)O₁₀(OH)₂, for example, can withstand temperatures of up to 1000° C. Further, the mica material can be suitably coated or laminated, for example with a high-temperature-resistant silicone.

Preferably, a thickness of a wall of the insulation element is in an area between 25% and 175% of a thickness of the wall of the at least one channel, more preferably in an area between 50% and 150% of the thickness of the wall of the at least one channel, more preferably in an area between 75% and 125% of the thickness of the wall of the at least one channel. Thickness is particularly to be understood as a dimension of the respective wall in the radial direction.

Further advantages and embodiments of the invention arise from the description and the accompanying drawings.

The invention is schematically represented in the drawing using exemplary embodiments and is described below with reference to the drawing.

### BRIEF DESCRIPTION OF THE DRAWINGS

FIG. 1 shows a preferred embodiment of a burner according to the invention in a schematic sectional view.

### EMBODIMENT(S) OF THE INVENTION

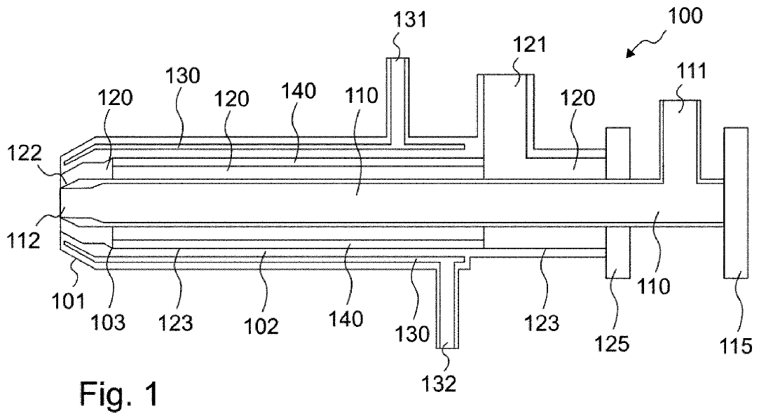

FIG. 1 shows a schematic sectional view of a preferred embodiment of a burner 100 according to the invention for performing partial oxidation.

The burner 100 is designed as a multi-channel burner and comprises a central channel 110 and an annular channel 120 surrounding this central channel 110. A fluid can flow through each of the channels 110, 120 for implementing the partial oxidation. For this purpose, the two channels 110, 120 can each be connected to a corresponding fluid supply via a corresponding fluid inlet or fluid port 111, 121, so that a corresponding fluid can flow from the fluid inlet 111 or 121 to a fluid outlet 112 or 122 in a burner tip 101. At an end of the central or annular channel 110 or 120 opposite the fluid outlet 112 or 122, for example, a closable flange port 115, 125 is provided in each case.

The respective fluids are emitted from the burner through these fluid outlets 112 and 122 to produce a synthesis gas in the form of a mixture of carbon monoxide and hydrogen in the course of partial oxidation. In the truncated cone-shaped burner tip 101, the annular channel 120 extends towards the central channel 110 at a predetermined angle of inclination or outlet angle, such that the respective fluid is emitted from the fluid outlet 122 at this corresponding angle of inclination or outlet angle relative to the fluid flow from the fluid outlet 112 of the central channel 110.

For example, an oxidizing agent in the form of an oxygen-containing gas, such as oxygen or air or an air-oxygen mixture, may be passed through the central channel 110. For example, a preheated fuel containing hydrocarbons, such as natural gas, may be passed through the annular channel 120. In particular, the fuel can be preheated to temperatures of up to 800° C. For this purpose, the central channel 110 can be connected via its fluid inlet or fluid port 111 to an oxidizing agent supply, for example, and the annular channel 120 can be connected via the fluid inlet or fluid port 121 to a fuel supply, for example. Further, the supplied fuel and/or the supplied oxygen-containing gas may each contain a moderator, for example in the form of water vapor, to regulate a ratio between hydrogen and carbon monoxide in the produced synthesis gas and/or to automatically perform a purge of the burner 100 in the event of a fault or malfunction.

A cooling channel 130 for a coolant for cooling the burner 100 is further provided in a wall 102 of the burner 100. A cooling fluid inlet 131 may be connected to a coolant supply such that a cooling fluid, for example water, may be continuously flowed from the cooling fluid inlet 131 through the cooling channel 130 to a cooling fluid outlet 132. For example, the temperature of the cooling fluid can be a maximum of 60° C.

In order to prevent or at least reduce heat exchange between the preheated fuel within the annular channel 120 and the cooling fluid within the cooling channel 130, an insulation element 140 is arranged on an inner face 123 of a wall 102 of the annular channel 120. For example, this wall 102 of the annular channel 120 may correspond to the wall 102 of the burner 100 in which the cooling channel 130 is provided.

The preheated fuel can be thermally insulated within the annular channel 120 by the insulation element 140, so that the fuel is not or at least hardly cooled by the cooling fluid in the cooling channel 130 and that conversely the cooling fluid is not or at least hardly heated by the fuel. Further, thermal stresses and mechanical stresses within the burner wall 102 due to the temperature difference between the fuel and the cooling fluid can be avoided or at least reduced. The service life of the burner 100 can thus be increased.

If the fuel supplied contains water vapor, the water vapor could condense on the inner wall face 123 of the annular channel 120 due to its high partial pressure, resulting in droplets that could damage the burner tip 101 by erosion. Due to the insulation element 140 arranged on this inner face 123, such condensation of water vapor and corresponding damage to the burner 100 can be avoided and the service life of the burner 100 can be increased.

This insulation element 140 is arranged along at least part of an axial length of the annular channel 120. For example, the insulation element 140 may extend at least from the fluid inlet 121 to a position 103 that is at a predeterminable axial distance from a forward end of the annular channel 120 as viewed in the flow direction. For example, this position 103 can correspond to the start of the burner tip 101.

The insulation element 140 is designed in the form of a tube, for example. In particular, a shape of the insulation element 140 or a shape of the outer (upper) surface of the insulation element 140 as viewed in the radial direction corresponds to a shape of the annular channel 120 or the inner (upper) surface 123 of the wall 102 of the annular channel 120, at least substantially. In particular, the insulation element 140 can thus be inserted axially into the annular channel 120 and can be flexibly removed again from the channel 120, for example through the flange port 125.

The insulation element 140 is expediently made of a heat-resistant, thermally insulating material, preferably of a mica or mica material, for example of a material containing muscovite and/or phlogopite.

Further, it is also possible to arrange a corresponding insulation element alternatively or additionally on the inner face of the wall of the central channel 110. It will be understood that the burner may also have a plurality of annular channels for supplying fluids, which may concentrically surround the central channel 110 and the annular channel 120. For example, several or even all of these annular channels may each have a corresponding insulation element, which is arranged on the inner wall face of the respective channel. Further, it is also conceivable, for example, that an insulation element is only arranged in the radially outermost annular channel, which is directly adjacent to the cooling channel in the radial direction.

### LIST OF REFERENCE SIGNS

100 burner for partial oxidation
101 burner tip
102 wall of the burner
103 beginning of the burner tip
110 central channel
111 fluid inlet
112 fluid outlet
115 flange port
120 annular channel
121 fluid inlet
122 fluid outlet
123 inner surface of the wall of the annular channel
125 flange port
130 cooling channel
131 cooling fluid inlet
132 cooling fluid outlet
140 insulating element

1. A burner for partial oxidation having at least two channels, which are particularly designed as a central channel and as at least one annular channel surrounding the central channel, through each of which a fluid can flow for implementing the partial oxidation,
wherein
an insulation element is arranged on an inner face of a wall of at least one channel of the at least two channels along at least part of an axial length of said at least one channel.

2. The burner according to claim 1, further having at least one cooling channel, through each of which a cooling fluid for cooling the burner can flow, wherein the at least one cooling channel annularly surrounds the at least two channels, wherein the insulation element (140) is arranged on the inner face (123) of the wall of the channel of the at least two channels adjacent to the at least one cooling channel, at least along part of an axial length of this adjacent channel.

3. The burner according to claim 1, wherein the at least one channel is configured to be connected to a fluid supply for supplying a preheated fluid and/or a fuel, particularly a preheated fuel.

4. The burner according to claim 1, wherein the insulation element is removable from the at least one channel.

5. The burner according to claim 1, wherein the insulation element is arranged in the at least one channel at least from a rear end of the at least one channel as viewed in the flow direction to a position which is at a predeterminable axial distance from a front end of the at least one channel as viewed in the flow direction, and/or wherein the insulation element is arranged in the at least one channel at least from a fluid port for supplying a fluid into the at least one channel to a position which is at a predeterminable axial distance from a front end of the at least one channel as viewed in the direction of flow.

6. The burner according to claim 1, wherein the insulation element extends in the at least one channel in the axial direction up to a burner tip.

7. The burner according to claim 1, wherein the insulation element is designed as a tube or tubular element.

8. The burner according to claim 1, wherein the insulation element is made of a thermally insulating material.

9. The burner according to claim 1, wherein the insulation element is made of a mica material.

10. The burner according to claim 1, wherein a thickness of a wall of the insulation element is in an area between 25% and 175% of a thickness of the wall of the at least one channel, particularly in an area between 50% and 150% of the thickness of the wall of the at least one channel, particularly in an area between 75% and 125% of the thickness of the wall of the at least one channel.
